(19) United States
(12) Patent Application Publication
(10) Pub. No.: US 2023/0386355 A1
(43) Pub. Date: Nov. 30, 2023

(54) Method And Device For Providing Learning Service By Using Digital Studying Method

(71) Applicant: DAEKYO CO., Ltd., Seoul (KR)

(72) Inventor: Ho Jun KANG, Seoul (KR)

(21) Appl. No.: 18/321,995

(22) Filed: May 23, 2023

(30) Foreign Application Priority Data
May 26, 2022 (KR) 10-2022-0064550

(51) Int. Cl. G09B 7/02; G09B 19/00; G06V 30/22; G06V 30/19; G06F 40/151

(52) U.S. Cl. CPC G09B 7/02; G09B 19/00; G06F 40/151; G06V 30/19147; G06V 30/22

(57) ABSTRACT

A method and a device for providing a learning service using a digitalized studying material are disclosed. The method includes providing a passage, and items associated with the passage to a learner interface—wherein the items include a non-descriptive item and a descriptive item—, obtaining a non-descriptive answer written by a learner in response to the non-descriptive item and a descriptive answer written by the learner in response to the descriptive item, calculating an achievement level of the learner based on the non-descriptive answer, calculating a reading index of the learner based on the descriptive answer, and providing a recommended learning content and a recommended book calculated based on the achievement level and the reading index of the learner to the learner interface.

### CROSS-REFERENCE TO RELATED APPLICATION

The present application claims priority to Korean Patent Application No. 10-2022-0064550, filed on May 26, 2022, in Korea, the entire contents of which are incorporated herein by reference.

### TECHNICAL FIELD

The present disclosure relates to a method and a device for providing a learning service using a digital studying material.

### BACKGROUND

The statements in this section merely provide background information related to the present disclosure and do not necessarily constitute prior art.

Education has been conducted as offline learning where professors conduct classes for learners at places such as schools and academies, but recently, due to the development of communication technology and environmental changes, the importance of online learning using communication is attracting attention.

Even in the case of language and/or literacy education, digitization of studying materials, e.g. textbook, workbook, lecture note, practice exercises, etc., is required in line with these changes. It is necessary to develop a learning service method that can customize learning at the learner level in the learning process using digitized studying materials for language and/or literacy studying.

### SUMMARY

According to an aspect of the present disclosure provides a method for providing a learning service. The method includes providing a passage, and items associated with the passage to a learner interface—wherein the items include a non-descriptive item and a descriptive item —, obtaining a non-descriptive answer written by a learner in response to the non-descriptive item and a descriptive answer written by the learner in response to the descriptive item, calculating an achievement level of the learner based on the non-descriptive answer, calculating a reading index of the learner based on the descriptive answer, and providing a recommended learning content and a recommended book calculated based on the achievement level and the reading index of the learner to the learner interface.

According to another aspect of the present disclosure provides a device for providing a learning service. The device includes one or more programmable processor; and a computer readable storage coupled to the one or more programmable processors and having instructions stored therein, the instructions, when executed by the one or more programmable processors, causes the one or more programmable processors to perform each process of the above-described method.

### BRIEF DESCRIPTION OF THE DRAWINGS

FIG. 1 is a block diagram illustrating a learning service platform according to one embodiment of the present disclosure.

FIG. 2 is a flowchart illustrating a learning service providing method according to one embodiment of the present disclosure.

FIGS. 3A to 3G are exemplary diagrams illustrating screens displayed on a learner interface according to one embodiment of the present disclosure.

FIG. 4 is a flowchart illustrating an operation of a learning service providing device according to one embodiment of the present disclosure.

FIG. 5 is an exemplary diagram for explaining a handwriting recognition method according to one embodiment of the present disclosure.

FIG. 6 is an exemplary diagram for explaining an answer scoring method according to one embodiment of the present disclosure.

FIG. 7 is an exemplary diagram for explaining a learner knowledge map according to one embodiment of the present disclosure.

### REFERENCE NUMERALS

100: learner interface
120: learning service providing device
140: database

### DETAILED DESCRIPTION

Aspects of the present disclosure provides method and device for a learning service that can greatly improve the effect of language and/or literacy learning by providing digitized learning studying materials and providing customized and variable learning prescriptions for each level of a learner.

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present disclosure and is not intended to represent the only embodiments in which the present disclosure may be practiced.

In the present disclosure, a user interface may be a physical medium or virtual medium implemented for the purpose of temporary or permanent access for interaction between a user and a thing or system (e.g., device, computer program, etc.). The user interface may refer to how a website or application program interacts with a learner, for example.

The user interface may include at least one input unit that can be manipulated by a user and at least one output unit that displays a result of the user's use. The user interface may include at least one object designed to interact with a user, such as a display screen, a keyboard, a mouse, text, an icon, and help. The user interface may be, for example, a web user interface (WUI), a graphical user interface (GUI), a command line interface (CLI), a touch user interface, a communication interface agent, a crossing-based interface, a gesture interface, an object-oriented user interface, a movement tracking interface, a multi-screen interface, a voice user interface, an end user interface, or the like, but is not limited thereto.

The user interface is a device loaded with a program designed to interact with a user and may be a personal computer (PC), a laptop, a smart phone, a tablet, a personal digital assistant (PDA), a game console, a portable multimedia player (PMP), a wireless communication terminal, a TV, a media player, or the like, but is not limited thereto.

A method of the present disclosure may be executed by a learning service providing device, and the learning service providing device may be executed on a computing device. The learning service providing device may perform each function by one or more processors available to the computing device, and may include a computer readable storage having instructions stored therein coupled with the processor.

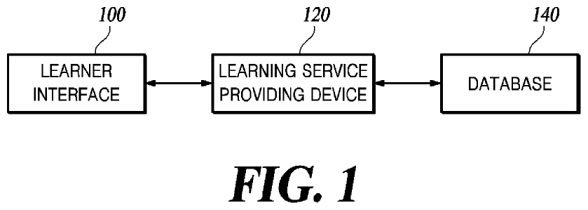

FIG. 1 is a block diagram illustrating a learning service platform according to one embodiment of the present disclosure.

A learning service platform 10 may include all or some of a learner interface 100 which is a user interface used by a learner, a learning service providing device 120, and a database 140. The learning service platform 10 illustrated in FIG. 1 is according to one embodiment of the present disclosure, and not all components illustrated in FIG. 1 are essential components, and some components may be added, changed, or deleted in other embodiments. For example, in another embodiment, a teacher interface that is a user interface used by a teacher conducting classes for a learner may be further included.

The learner interface 100 may provide a learning content to the learner by interacting with the learning service providing device 120. The learner interface 100 can access a web page or application providing a learning service in response to manipulation of the learner.

As the learning content, the learner interface 100 may receive a passage and one or more items associated with the passage. The learner interface 100 may display them on a display screen. The learner interface 100 may receive the manipulation of the learner and store the manipulation on its own, perform an operation on the input, or transmit the manipulation to the learning service providing device 120. The learner interface 100 may receive a response to the request of the learner from the learning service providing device 120 and display the response on the display screen.

The learning service providing device 120 may provide a learning service using digitalized studying materials. To this end, the learning service providing device 120 may perform interaction with the learner interface 100. For example, the learning service providing device 120 may receive a request from the learner interface 100, perform a function corresponding to the request, and transmit a response to the request to the learner interface 100.

In one embodiment, the learning service providing device 120 may be a server operated by an operator providing a learning service, but the present disclosure is not limited thereto. For example, according to another embodiment of the present disclosure, the functions of the learning service providing device 120 may be integrated into the learner interface 100 and implemented.

The database 140 may store all of some of a passage for each learning content, one or more items associated with each passage, a correct answer for each item, handwriting answers of one or more learner for each answer, information on the one or more learner, studying material information, a learning history, a learner knowledge map, and/or a recommended book for each learning content. The database 140 may further store, as an identifier of each learner and data for each learner so that the learning service providing device 120 can provide a customized learning service to the learner. The data for each learner may include all or some of handwriting information, an incorrect answer tendency, and a handwriting recognition model that learns the handwriting information of learner.

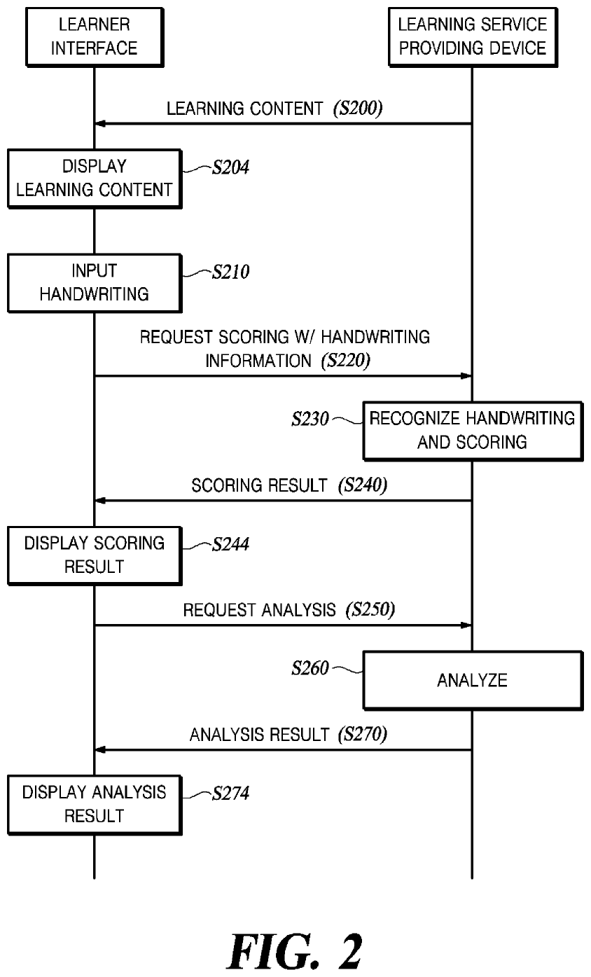

FIG. 2 is a flowchart illustrating a learning service providing method according to one embodiment of the present disclosure.

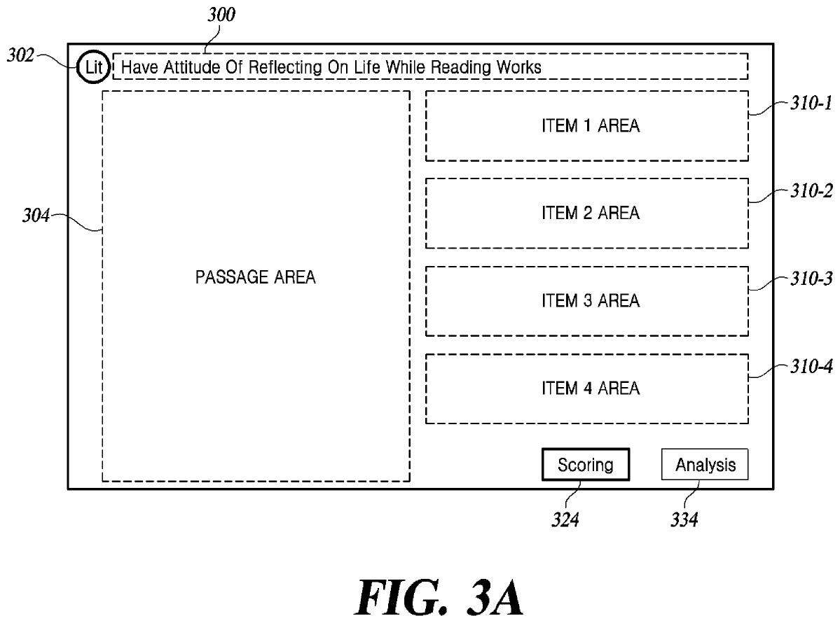

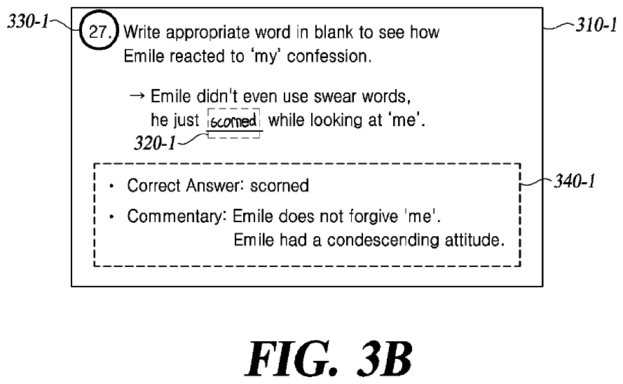

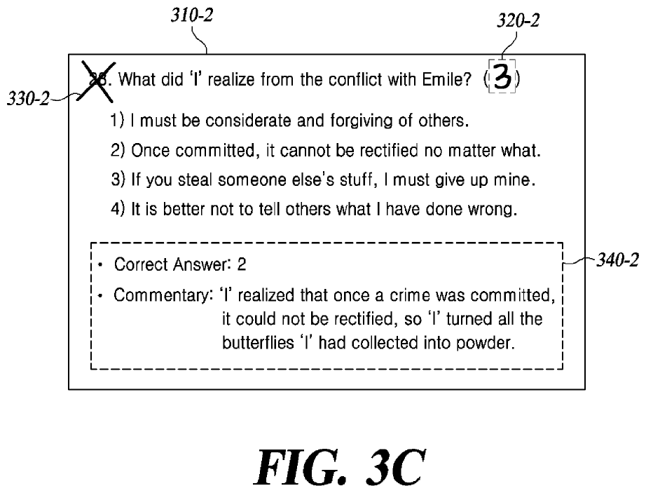

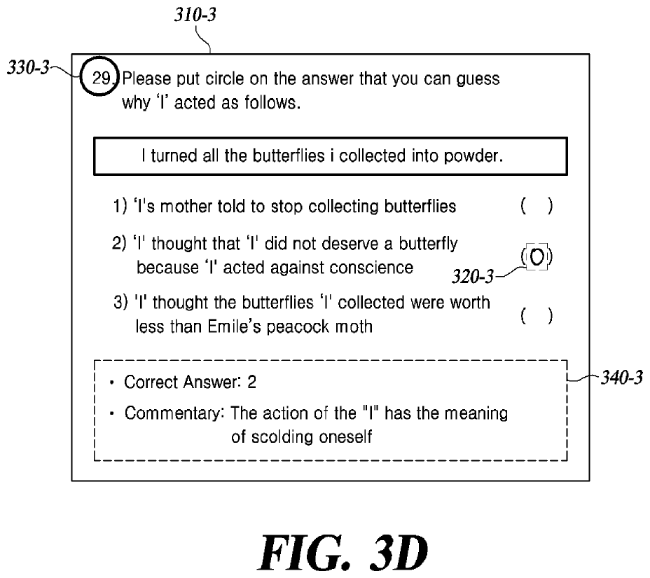

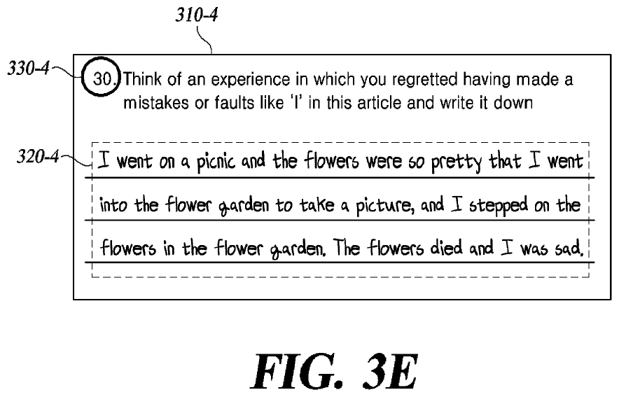

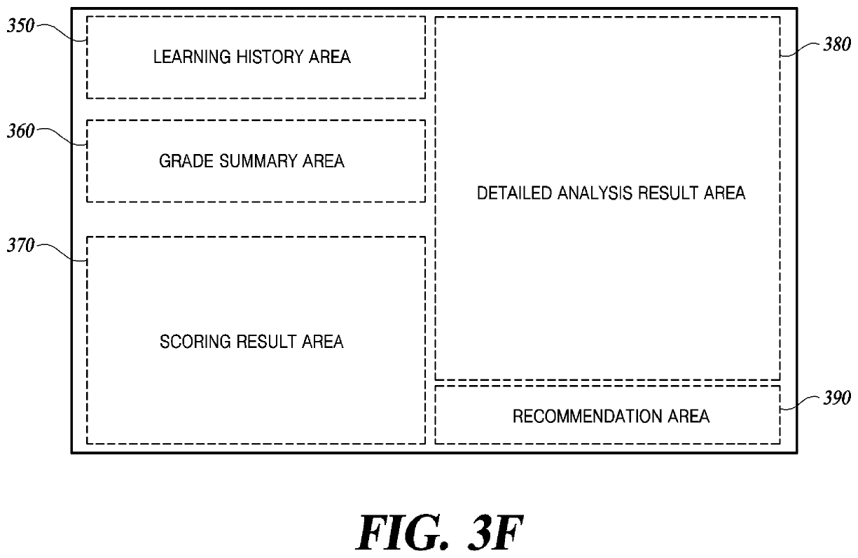

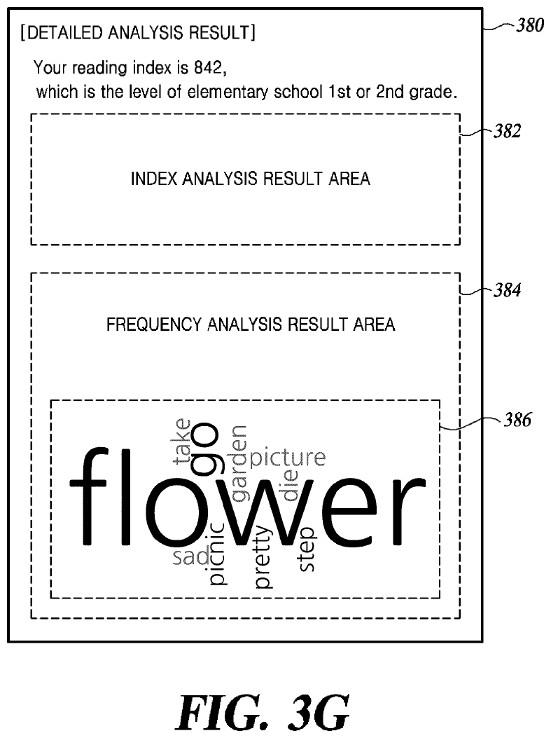

FIGS. 3A to 3G are exemplary diagrams illustrating screens displayed on the learner interface according to one embodiment of the present disclosure.

The learning service providing device 120 may transmit the learning content to the learner interface 100 (S200), and the learner interface 100 may display the received learning content on the screen (S204).

Here, the learning content may include a literary or non-literary passage, one or more non-descriptive items associated with the passage, and one or more descriptive items associated with the passage. For example, the learning content may include a passage and 30 items associated with the passage. The last item may be a descriptive item for calculating a reading index and other items may be a non-descriptive items for calculating an achievement level. The non-description items may include, for example, one or more of a short answer type item, an OX type item, a selective type item, and a subjective type item.

In one embodiment, the learning service providing device 120 may transmit a learning document, which is a visualized learning content, to the learner interface 100. Here, the learning document may have a format such as hwp, doc, pdf, jpeg, png, but is not limited thereto.

For example, as illustrated in FIG. 3A, the learning document including all or some of a learning topic area 300 in which a learning topic of a current learning content is displayed, a passage area 304 in which a passage of the current learning content is displayed, a genre area 302 in which a genre of the passage (e.g., literature or non-literature) is displayed, and item areas 310-1 to 310-4 in which items associated with the passage are displayed respectively. FIGS. 3B to 3E show examples of item areas 310-1 to 310-4 in which a short answer type item, a selective type item, an OX type item, and a descriptive type item are displayed respectively. Meanwhile, FIG. 3A illustrates an example in which the learner interface 100 displays the passage and at least some of the items together on one screen, but the present disclosure is not limited thereto.

The learner interface 100 may receive a handwritten user input from the learner (S210). The learner interface 100 may display handwriting objects 320-1 to 320-4 input by the learner together on the learning document, as illustrated in FIGS. 3B to 3E.

When the learning of the learner is completed, the learner interface 100 may transmit a scoring request to the learning service providing device 120 (S220). For example, the learner interface 100 may display and/or activate a scoring request button 324 when handwriting is input to all answer areas on the learning screen or a preset solving time elapses, and may transmit the scoring request to the learning service providing device 120 when a touch input of the corresponding button 324 is input.

The scoring request may include the handwriting information of the learner. Here, the handwriting information may refer to information related to user input in the form of handwriting input to the learner interface 100 while the learner performs learning. For example, the handwriting information may include handwriting object in the form of a vector image or raster image. According to embodiments, the handwriting information may include a source learning document on which a handwriting input of the learner may be displayed. According to embodiments, the handwriting information may include a handwritten document in which the handwriting input is added to the source learning document.

The learning service providing device 120 may obtain the answer of the learner for each item from the handwriting information based on a handwriting recognition technology, and determine whether the answer of the learner is correct or not (S230).

The learning service providing device 120 may transmit the scoring result for the answer of the learner to the learner interface 100 (S240), and the learner interface 100 may display the received scoring result on the screen (S244). For example, as illustrated in FIGS. 3B to 3E, the learner interface 100 may display a scoring result screen including all or some of the scoring result objects 330-1 to 330-4 for each item and correct answer/commentary objects 340-1 to 340-3 for each item.

The learner interface 100 may transmit an analysis request for the scoring result to the learning service providing device 120 (S250). The learner interface 100 may display or activate the analysis request button 334 in response to receiving the scoring result from the learning service providing device 120. When a touch input of the button 334 is received, the learner interface 100 may transmit the analysis request to learning service providing device 120.

In response to the analysis request, the learning service providing device 120 may analyze the answer of learner and/or the scoring result (S260). The learning service providing device 120 may calculate a recommended learning content and a recommended book. The learning service providing device 120 transmit the analysis result including them to the learner interface 100 (S270).

The learner interface 100 may display the received analysis result on the screen (S274). The learner interface 100 may display an analysis result document, which is a visualized analysis result, on the screen. For example, as illustrated in FIGS. 3F and 3G, an analysis result document may include all or some of a learning history area 350 in which a learning history for current learning content is displayed, a grade summary area 360 in which comprehensive scoring result is displayed, a scoring result area 370 in which a scoring result for each item is displayed, a detailed analysis result area 380 in which analysis result for a descriptive item is displayed, and/or a recommendation area 390 in which recommended learning progress is displayed. Here, the recommended learning progress may include recommended learning content and/or recommended book.

Table 1 shows an example of the learning history that can be displayed in the learning history area 350.

TABLE 1

| Date of Examination | Start Time | End Time |
|---|---|---|
| Mar. 28, 2022 | 14:31:49 | 15:35:49 |

Table 2 shows an example of the comprehensive scoring result that can be displayed in the grade summary area 360.

TABLE 2

| | [45 sets: literature] |
|---|---|
| | having an attitude of reflecting |
| Topic | on life while reading works |
| Number of correct answers | 18/30 |
| Average score | 60/100 |

Table 3 shows an example of the scoring result for each item that can be displayed in the scoring result area 370.

TABLE 3

| No. | 1 | 2 | 3 | 4 | 5 | 6 | 7 | 8 | 9 | 10 |
|---|---|---|---|---|---|---|---|---|---|---|
| Result | ◯ | ◯ | X | X | X | X | ◯ | ◯ | X | ◯ |
| No. | 11 | 12 | 13 | 14 | 15 | 16 | 17 | 18 | 19 | 20 |
| Result | ◯ | X | ◯ | ◯ | ◯ | X | ◯ | ◯ | X | ◯ |
| No. | 21 | 22 | 23 | 24 | 25 | 26 | 27 | 28 | 29 | 30 |
| Result | ◯ | ◯ | X | ◯ | X | X | ◯ | X | ◯ | ◯ |

Referring to FIG. 3G, the detailed analysis result area 380 may include an index analysis result area 382 in which an analysis result for detailed indexes regarding the reading index is displayed, and a frequency analysis result area 384 in which a frequency analysis result about an answer to a descriptive item is displayed.

Table 4 shows an example of the analysis result for detailed indexes that can be displayed in the scoring result area 382.

TABLE 4

| Index | | Value |
|---|---|---|
| Detailed | a ratio of complex sentences | 0.5 |
| Index 1 | a ratio of simple sentences | 0.5 |
| | a ratio of difficult words | 0 |
| | a lexical diversity | 0.75 |
| Detailed | an average length of sentences | 8.5 |
| Index 2 | a sentence structure score | 13.48 |
| | a ratio of noun/predicate | 1 |

Table 5 shows an example of the frequency analysis result that can be displayed in the frequency analysis result area 384.

TABLE 5

| Name | Value |
|---|---|
| the number of characters | 186 |
| the number of paragraphs | 1 |
| the number of sentences | 2 |
| the number of words | 39 |
| the number of difficult words | 0 |
| the number of complex sentences | 1 |
| the number of predicates | 7 |

The frequency analysis result area 384 may include a visualization analysis result 386 using a wordcloud. For example, within the answer of the learner for a descriptive item, high-frequency vocabulary with a high frequency of appearance based on a frequency of word appearance can be visualized and provided together. Here, among the vocabularies displayed on the screen, a word with a relatively high frequency of appearance can be visualized and displayed in a larger and darker manner.

Table 6 shows an example of the recommended learning progress that can be displayed in the recommendation area 390. Here, the recommended learning progress may include recommended learning content and/or recommended book.

TABLE 6

| Recommended learning progress | Example of text to be displayed |
|---|---|
| recommended learning content | [49 sets: listening and speaking] |
| | Listening while judging validity |
| recommended book | |

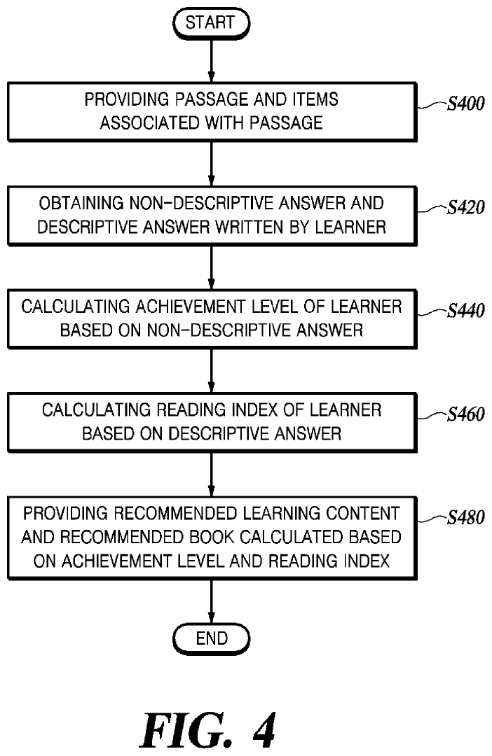

FIG. 4 is a flowchart illustrating an operation of the learning service providing device according to one embodiment of the present disclosure.

The learning service providing device 120 may provide a learning content including a passage and items associated with the passage to the learner interface 100 (S400). Here, the items may include one or more non-descriptive items and one or more descriptive items.

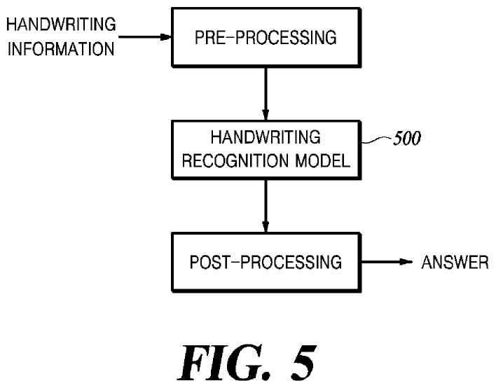

The learning service providing device 120 may obtain one or more non-descriptive answer written by of a learner in response to each non-descriptive item and one or more descriptive answer written by the learner in response to each descriptive item (S420). For example, the learning service providing device 120 may receive the handwriting information inputted by the learner on the learner interface 100 and obtain the answer of the learner from the handwriting information by using a pre-trained handwriting recognition model. A specific example in which the learning service providing device 120 obtains the answer of the learner using the handwriting recognition model will be described later with reference to FIG. 5.

The learning service providing device 120 may calculate an achievement level of the learner based on the non-descriptive answer (S440). Here, the achievement level of the learner may mean a correct answer rate of the learner to the one or more non-descriptive items.

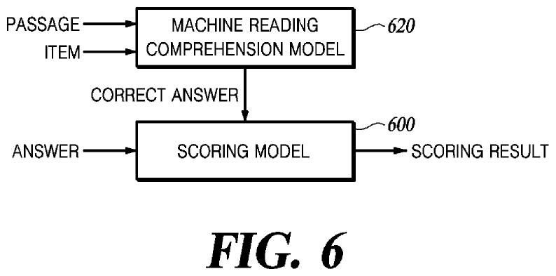

In one embodiment, the learning service providing device 120 may determine the correctness of the answer based on whether the answer of the learner to the non-descriptive item matches the correct answer obtained from the database 140. In another embodiment, the learning service providing device 120 may input the answer of the learner to the non-descriptive item into a pre-trained scoring model to determine the correctness of the answer. For example, the learning service providing device 120 may use the pre-trained scoring model to determine the correctness of the answer of the learner to the subjective item among the non-descriptive items. A specific example in which the learning service providing device 120 determines the correctness of the answer of the learner using the scoring model will be described later with reference to FIG. 6.

The learning service providing device 120 may calculate the reading index of the learner based on the descriptive answer (S460).

In one embodiment, the learning service providing device 120 may calculate the reading index according to a pre-specified score calculation algorithm based on levels of words, sentences, and paragraphs included in the answer of the learner to the descriptive item. The word level may be calculated according to a predetermined calculation algorithm using some or all of pieces of information such as the number of words, an average grade of words, a frequency of words, the number of difficult words, and a ratio of difficult words. The sentences level may be calculated according to a predetermined calculation algorithm using some or all of pieces of information such as the number of sentences, an average sentence length, a ratio of simple sentences, a ratio of complex sentences, and a sentence structure score. The paragraph level may be calculated according to a predetermined calculation algorithm using some or all of pieces of information such as the number of paragraphs and cohesion between paragraphs. The cohesion between paragraphs may be calculated using a Latent Semantic Analysis (LSA) method, which analyzes a semantic relationship between paragraphs by embedding each paragraph into a vector space and then calculating a cosine similarity between these embedding vectors, but the present disclosure is not limited thereto.

In another embodiment, the learning service providing device 120 may calculate the reading index of the learner from the answer of the learner to the descriptive item using an optimal model determined by linear regression analysis or machine learning.

The learning service providing device 120 may determine that the answer corresponding descriptive item is correct when the reading index of the learner calculated based on the answer to the specific descriptive item is equal to or more than the preset reference value.

The learning service providing device 120 may visualize the scoring result for the answer of the learner and provide the visualized scoring result to the learner interface 100. For example, the learning service providing device 120 may transmit a scoring document to the learner interface 100. Here, the scoring document may include a learning document to which handwriting input is added, an image corresponding to a scoring result (e.g. correct or incorrect), a correct answer text, and/or a commentary text. As another example, the learning service providing device 120 may transmit an image corresponding to the scoring result, the correct answer text, and the commentary text along with information on a location where the corresponding image and/or text will be overlaid on the learning document to the learner interface 100.

The learning service providing device 120 may provide the recommended learning content and recommended book calculated based on the achievement level and reading index of the learner to the learner interface 100 (S480).

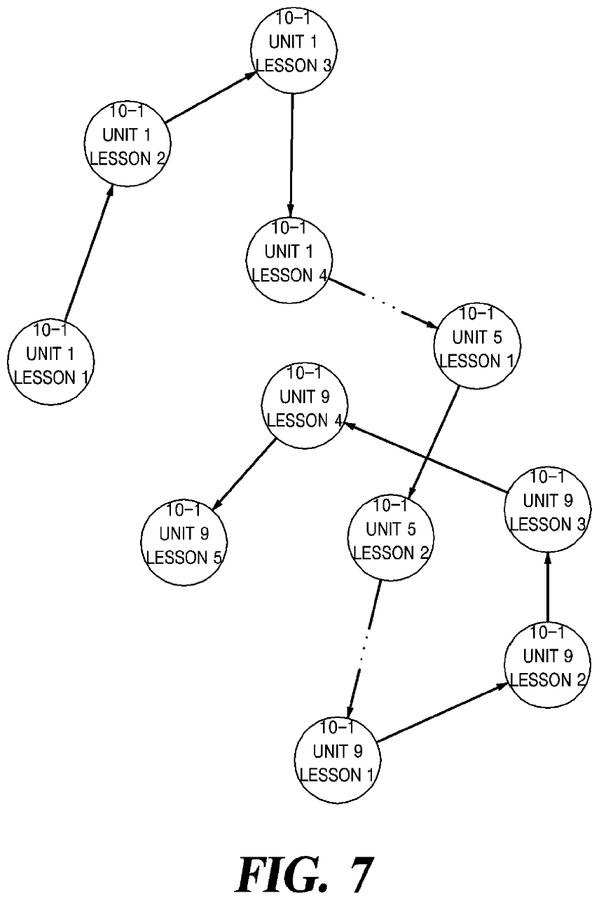

The learning service providing device 120 may acquire a learner knowledge map in which a connection relationship between one or more learning contents is defined, change at least one connection relationship in the learner knowledge map based on the calculated achievement level and reading index, and provide the learning content connected with a current learning content provided in Step S400 by an outgoing edge within the updated the learner knowledge map to the learner interface as the recommended learning content. Here, the learning service providing device 120 may change at least one connection relationship within the learner knowledge map based on at least one of a target grade of each learning content, a target semester of each learning content, a unit of each learning content, a topic of each learning content, a passage of each learning content, an attribute of each passage, a reading index of each passage, the number of words used in each passage, the number of sentences used in each passage, the number of items associated with each passage, and an attribute of each item, but the present disclosure is not limited thereto. A specific example of the learner knowledge map will be described later with reference to FIG. 7.

The learning service providing device 120 may provide, as the recommended book, a book corresponding to a type which is dynamically determined among a plurality of type based on whether the achievement level and the reading index are equal to or more than the preset reference value, respectively, to the learner interface 100. Here, the plurality of type may include a first type, a second type, and a third type. The first type may correspond to a case where the achievement level is less than a reference correct answer rate and the reading index is less than a reference reading index. In addition, the second type may correspond to a case that does not correspond to the first type, and the achievement level is less than the reference correct answer rate or the reading index is less than the reference reading index. In addition, the third type may correspond to a case where the achievement level is equal to or more than the reference correct answer rate and the reading index is equal to or more than the reference reading index.

To this end, the learning service providing device 120 may obtain the reference correct answer rate, the reference reading index, and a list of books by type corresponding to the current learning content from the database 140.

Table 7 is a table exemplifying some of the reference correct answer rates and the reference reading indexes corresponding to learning contents, and Table 8 is a table exemplifying some of the list of books by type corresponding to learning content.

TABLE 7

| | | | | | Reference | |
|---|---|---|---|---|---|---|
| | | | Passage | Reference | correct | Reference |
| | | | reading | solving | answer | reading |
| No. | Passage title | Author | index | time | rate | index |
| 1 | During five minutes | Hee-deok Na | 1600 | 360 | 80% | 1300 |
| 2 | Spring Spring | Yu-jeong Kim | 1610 | 300 | 80% | 1300 |
| 3 | Monk | Se-deok Ham | 1620 | 300 | 80% | 1300 |
| 4 | Where did we come | In-ho Choi | 1630 | 360 | 80% | 1450 |
| | from | | | | | |
| 5 | Western Painting, | Jeong-suk Kim | 1725 | 480 | 80% | 1450 |
| | Awakening Joseon | | | | | |
| 6 | How thoughts are born | Dennis Hong | 1733 | 400 | 80% | 1500 |
| 7 | Jemangmaega | Wolmyeongsa | 1800 | 300 | 80% | 1500 |
| | | Temple | | | | |
| 8 | Ouga | Seon-do Yun | 1860 | 250 | 80% | 1600 |
| 9 | Sokmi Ingok | Cheol Jeong | 1901 | 450 | 80% | 1700 |
| 10 | Chunhyangjeon | unknown | 1925 | 500 | 80% | 1750 |
| 11 | Homesick | Ji-yong Jeong | 1930 | 550 | 80% | 1750 |

TABLE 8

| Learning content | | | | Recommended book | |
|---|---|---|---|---|---|
| No. | Passage Title | Author | Type | Book name | Author |
| 1 | During five minutes | Hee-deok Na | 1 | Sorrow to joy | Ho-seung Jung |
| | | | 1 | That flower | Eun Go |
| | | | 2 | Self-portrait | Dong-ju Yun |
| | | | 3 | First love | Jae-jong Go |
| | | | 3 | I | Kwang-gyu Kim |
| 2 | Spring Spring | Yujeong Kim | 1 | Moonlight | Tae-Jun Lee |
| | | | 2 | Choicheokjeon | Wi-han Jo |
| | | | 3 | Stone bridge | Tae-jun Lee |
| | | | 3 | Seongbuk-dong dove | Gwang-seop Kim |
| 3 | Monk | Se-deok Ham | 1 | Watchman | Kang-baek Lee |
| | | | 2 | Sogwang-ri pine forest | Yong-bok Shin |
| | | | 3 | Angry machine | Bum-seok Cha |
| 4 | Where did we come from | Inho Choi | 1 | Place to wail | Ji-won Park |
| | | | 2 | Freedom and regulation | Young-hee Lee |
| | | | | of scientific research | |
| | | | 3 | Above | Ji-won Park |

According to embodiments, the learning service providing device 120 may directly calculate the reference correct answer rate and the reference reading index corresponding to the learning content based on the reading index, difficulty, the number of related items, and/or the solving time of the passage within the learning content.

Meanwhile, when there are several books having the type corresponding to the calculated achievement level and calculated reading index, the learning service providing device 120 may determine a randomly determined specific book among the books as the recommended book. For example, when the passage learned by the learner is “for five minutes” and the type corresponding to the achievement level and the reading index of the learner is the first type, the learning service providing device 120 may provide the learner interface 100 with a book randomly selected from the “sadness to joy” and “the flower” as the recommended book.

FIG. 5 is an exemplary diagram for explaining a handwriting recognition method according to one embodiment of the present disclosure.

The learning service providing device 120 may perform pre-processing on the handwriting information obtained from the learner interface 100. In one embodiment, the learning service providing device 120 may separate the learning content and the handwriting object from the handwritten document in which the handwriting input is added to the source learning document. As another example, the learning service providing device 120 may separate handwriting objects for each item based on the position where each item is placed in the learning document, the position of the answer area of each item, and/or the position where the handwriting input is added.

The learning service providing device 120 may convert the handwriting object into text by inputting the separated handwriting object into a pre-trained handwriting recognition model. Here, the handwriting recognition model 500 may be a machine learning or artificial intelligence-based learning model.

In one embodiment, the learning service providing device 120 may include a plurality of handwriting recognition models. For example, the plurality of handwriting recognition models may include a first handwriting recognition model trained to convert the handwriting object into a character string used for notating the language in which learner is currently studying (e.g. Hangul strings, Hiragana strings, Chinese character string, Alphabet string, etc.). The plurality of handwriting recognition models may include a second handwriting recognition model trained to convert the handwriting object into a number. The plurality of handwriting recognition models may include a third handwriting recognition model trained to convert the handwriting object to an alphabetic string. The learning service providing device 120 may obtain the answer for each item by inputting the handwriting object for each item into at least one of handwriting recognition models. The learning service providing device 120 may determine the target handwriting recognition model to input each handwriting object based on the detailed type of each item corresponding to each handwriting object. For example, the first handwriting recognition model may be used for handwriting object corresponding to the subjective type item and the descriptive type item. The second handwriting recognition model may be used for handwriting object corresponding to the selective type item. The third handwriting recognition model may be used for the OX-type item, but is not limited thereto.

The learning service providing device 120 may post-process the recognition error of the handwriting recognition model. For example, the learning service providing device 120 may correct errors by distinguishing similarly shaped letters (similar pairs) or correct errors by reflecting contextual information. The learning service providing device 120 may post-process recognition errors using a language model or dictionary trained in advance based on a large amount of corpus, but is not limited thereto.

When the difference between the correct answer to the non-descriptive item and text recognized from the learner's handwriting answer is within a preset threshold value, the learning service providing device 120 may additionally train the pre-trained handwriting recognition model. Here, the handwriting information and the correct answer to the non-descriptive item are used as the learning data. That is, the parameters of the handwriting recognition model may be updated with the handwriting information, the correct answer to the non-descriptive item, and the answer of the learner as the input data of the handwriting recognition model, the ground truth for the input data, and the output data of the handwriting recognition model, respectively. The learning service providing device 120 may determine whether to further additionally train the recognition of the handwriting recognition model based on the number of grapheme elements or the number of syllables that differs between the correct answer, or the difference in the number of strokes between the different grapheme elements or syllables. For example, when the number of grapheme elements or syllables that differ between the correct answer and the answer of the learner to a subjective short-answer item is within the number of presets, or when the difference in the number of strokes between different grapheme elements or syllables is within the number of presets, it is determined that there is an error in the recognition of the handwriting recognition model, and parameters of the handwriting recognition model can be updated to minimize the correct answer and the loss calculated based on the answer. To this end, the learning service providing device 120 may obtain the correct answer to the non-descriptive item from the database 140, but is not limited thereto.

FIG. 6 is an exemplary diagram for explaining an answer scoring method according to one embodiment of the present disclosure.

Referring to FIG. 6, the learning service providing device 120 may determine the correctness of the answer converted to text using a pre-trained scoring model 600. Here, the scoring model 600 may be may be a machine learning or deep learning-based artificial intelligence model. In one embodiment, the scoring model 600 may be trained to determine the correctness of the answer based on similarity between embedding vectors for the correct answer to the non-descriptive item and the answer of the learner to the non-descriptive item. For example, the scoring model 600 may determine the correctness of the answer by calculating a cosine similarity between the correct answer embedding and the answer embedding in the vector space, but is not limited thereto.

In one embodiment, the learning service providing device 120 may obtain one or more correct answers to the non-descriptive item by inputting at least a part of the passage and the non-descriptive item into the pre-trained machine reading comprehension model 620. Here, the machine reading comprehension model 620 may be a pre-trained language model that has been trained to perform contextual embedding, such as Bidirectional Encoder Representations from Transformers (BERT) or Generative Pre-Training model (GPT), but is limited thereto. The machine reading comprehension model 620 may be pre-trained through a predetermined upstream task and fine-tuned to be suitable for a machine reading comprehension task as a downstream task.

In another embodiment, the learning service providing device 120 may obtain the answer of the learner to each non-descriptive item from the database 140 and input the answer to the scoring model 600.

As described above, the learning service providing device 120 can secure flexibility in scoring by performing scoring using the pre-trained scoring model 600 and/or the machine reading comprehension model 620.

FIG. 7 is an exemplary diagram for explaining the learner knowledge map according to one embodiment of the present disclosure.

The learner knowledge map is a data structure representing learning contents as nodes, and may be a graph or a digraph, but the learner knowledge map is not implemented only with this data structure. The learner knowledge map can represent a relationship between nodes as an edge, especially an outgoing edge.

As illustrated in FIG. 7, the initial learner knowledge map may sequentially couple the learning contents based on a grade, a semester, a unit, and a lesson. For example, the node of “10th Grade 1st Semester unit 1 Lesson 1”, the node of “10th Grade 1st Semester unit 1 Lesson 2”, the node of “10th Grade 1st Semester unit 1 Lesson 3”, and the node of “10th Grade 1st Semester unit 1 Lesson 4” can be sequentially coupled in this order through the outgoing edges.

The learning service providing device 120 may update the learner knowledge map based on all or some of the achievement level of the learner, the reading index, and/or the label of the learning content for a specific learning content. Here, the label of the learning content is associated with the target grade of the learning content, the semester of the learning content, the unit of the learning content, the topic of the learning content, the passage of the learning content, the attribute of the passage, the reading index of the passage, the number of words used in the passage, the number of sentences used in the passage, the number of items associated with the passage, the number of items per type, and/or the type of each item. Table 8 show some example of the labels of the learning content.

TABLE 9

| Label name | | Remarks |
|---|---|---|
| Learning topic | | Topic of current learning content |
| Title of passage | | |
| Author of passage | | |
| Reading index of passage | | Reading index calculated for passage |
| Difficulty of passage | | |
| Target grade | | Recommended (or ideal) grade/semester for studying current |
| Target semester | | learning content e.g. first semester of 5th grade |
| Unit | | Comprehensive learning unit within a curriculum that focuses |
| | | on a specific portion or theme |
| Lesson | | Individual learning session within a unit |
| Number of words | | Number of words used in passage |
| Number of sentences | | Number of sentences used in passage |
| Classification | | e.g. Full text, Excerpt, or the like |
| Attribute | Genre | e.g. Literary, Non-literary, or the like. |
| | Detailed categories | e.g. explanatory text, novel, research record, introduction, |
| | | editorial, seminal essay, novel, poetry, or the like |

| | |
|---|---|
| Total number of items coupled | Number of items associated with the passage |
| Number of short answer items | Number of items having corresponding type |
| Number of OX type items | |
| Number of selective items | |
| Number of subjective items | |
| Number of descriptive items | |
| Reference solving time | Sum of solving time for each item set for each item |
| Reference correct answer rate | Value to be compared with the correct answer rate of learner |
| Reference reading index | Value to be compared with the reading index of learner |

The learning content providing device 120 may update the learner knowledge map by, for example, creating a new node or edge in the learner knowledge map or deleting an existing node or edge. For example, when the reading index of the learner for a specific learning content is less than the preset threshold, the learning service providing device 120 may consider that the learner has not understood the passage of the learning content, and create a new node or edge so that the learning content and another learning content having a similar attribute passage or reading index of the passage are coupled, but is not limited thereto.

According to embodiments, the learning service providing device 120 may update the learner knowledge map using a machine learning or artificial intelligence-based learner knowledge map personalization model. In this case, the learner knowledge map personalization model may generate a personalized learner knowledge map by using the achievement level of the learner, the reading index, the label of each learning content, and the like as features. This learner knowledge map personalization model can generate a learning map capable of providing an optimal learning path to each learner by further learning the learner knowledge map generated for various learners and the process of updating each learner knowledge map.

The learning service providing device 120 may determine an adjacent node coupled by the outgoing edge from the node of learning content where a learner has performed learning at present as the recommended learning content. Meanwhile, although not illustrated in FIG. 7, when a plurality of adjacent nodes exists, the recommended learning content may be determined for one adjacent node determined according to a preset method.

Since nodes and edges of the learner knowledge map can be changed in real time through interaction with the learner interface 100, the recommended learning content can be dynamically determined.

According to one embodiment of the present disclosure, an effect of learning a language and/or a literacy can be greatly improved by providing digitized studying materials studying material and providing customized and variable learning prescriptions for each level of a learner.

According to one embodiment of the present disclosure, a digital learning service capable of self-study can be provided by automatically scoring a handwritten answer written by a learner during learning in a non-face-to-face manner without the need for a teacher to directly score the answer. In addition, learning data can be acquired through a handwriting database of learners, and a handwriting recognition model can be trained using the learning data.

According to one embodiment of the present disclosure, by using the reading index proposed based on big data, the reading difficulty level of the passage in the studying material studying material is guided to the learner, so that a language and/or a literacy learning suitable for a reading comprehension level of the learner can be realized.

According to one embodiment of the present disclosure, a personalized learning prescription is possible through an artificial intelligence based customized learning algorithm that accurately pinpoints only weak points of the learner by identifying an error tendency of the learner based on an item attribute database.

The features of the present disclosure are not limited to the features mentioned above, and other features not mentioned will be clearly understood by those skilled in the art from the description above.

Each component of the apparatus or method according to the present disclosure may be implemented as hardware or software, or a combination of hardware and software. Furthermore, the function of each component may be implemented as software and a microprocessor may be implemented to execute the function of software corresponding to each component.

Various implementations of systems and techniques described herein may be realized as digital electronic circuits, integrated circuits, field programmable gate arrays (FPGAs), application-specific integrated circuits (ASICs), computer hardware, firmware, software, and/or combinations thereof. These various implementations may include one or more computer programs executable on a programmable system. The programmable system includes at least one programmable processor (which may be a special-purpose processor or a general-purpose processor) coupled to receive and transmit data and instructions from and to a storage system, at least one input device, and at least one output device. The computer programs (also known as programs, software, software applications, or codes) contain commands for a programmable processor and are stored in a “computer-readable recording medium”.

The computer-readable recording medium includes all types of recording devices in which data readable by a computer system is stored. Such a computer-readable recording medium may be a non-volatile or non-transitory medium, such as a read-only memory (ROM), compact disk ROM (CD-ROM), magnetic tape, floppy disk, memory card, hard disk, magneto-optical disk, or storage device, and may further include a transitory medium such as a data transmission medium. In addition, the computer-readable recording medium may be distributed in a computer system connected via a network, so that computer-readable codes may be stored and executed in a distributed manner.

The flowchart/timing diagram of the present specification describes that processes are sequentially executed, but this is merely illustrative of the technical idea of an embodiment of the present disclosure. In other words, since it is apparent to those having ordinary skill in the art that an order described in the flowchart/timing diagram may be changed or one or more processes may be executed in parallel without departing from the essential characteristics of an embodiment of the present disclosure, the flowchart/timing diagram is not limited to a time-series order.

Although exemplary embodiments of the present disclosure have been described for illustrative purposes, those having ordinary skill in the art should appreciate that various modifications, additions, and substitutions are possible, without departing from the idea and scope of the claimed disclosure. Therefore, exemplary embodiments of the present disclosure have been described for the sake of brevity and clarity. The scope of the technical idea of the present embodiments is not limited by the illustrations. Accordingly, one of ordinary skill in the art would understand that the scope of the claimed disclosure is not to be limited by the above explicitly described embodiments but by the claims and equivalents thereof

What is claimed is:

1. A method, performed by an electronic device, for providing learning service, the method comprising:
providing a passage, and items associated with the passage to a learner interface—wherein the items include a non-descriptive item and a descriptive item—;
obtaining a non-descriptive answer written by a learner in response to the non-descriptive item and a descriptive answer written by the learner in response to the descriptive item;
calculating an achievement level of the learner based on the non-descriptive answer;
calculating a reading index of the learner based on the descriptive answer; and
providing a recommended learning content and a recommended book calculated based on the achievement level and the reading index of the learner to the learner interface.

2. The method of claim 1, wherein the achievement level of the learner is a correct answer rate of the non-descriptive answer.

3. The method of claim 1, wherein the calculating of the achievement level of the learner includes:
determining whether the non-descriptive answer is correct or not by inputting the non-descriptive answer into a pre-trained scoring model.

4. The method of claim 3, wherein the scoring model has been trained to determine correctness of the non-descriptive answer based on a similarity between embedding vectors for the non-descriptive and a correct answer to the non-descriptive item.

5. The method of claim 4, wherein the calculating of the achievement level of the learner further includes:
obtaining a correct answer to the non-descriptive item by inputting at least a part of the passage and the non-descriptive item into a pre-trained machine reading comprehension model.

6. The method of claim 1, further comprising, after the calculating of the reading index of the learner, determining that the descriptive answer is correct when the reading index of the learner is equal to or more than a preset reference value.

7. The method of claim 1, further comprising:
visualizing a scoring result for the non-descriptive answer and the descriptive answer; and
providing the visualized scoring result to the learner interface.

8. The method of claim 1, wherein the providing of the recommended learning content and the recommended book includes:
providing, as the recommended book, a book corresponding to a type, which is dynamically determined among a plurality of types based on whether each of the achievement level and the reading index is equal to or more than a preset reference value, to the learner interface.

9. The method of claim 8, wherein the plurality of types includes:
a first type corresponding to a case where the achievement level is less than a first reference value and the reading index is less than a second reference value,
a second type that does not correspond to the first type, and corresponds to a case where the achievement level is less than the first reference value or the reading index is less than the second reference value, and
a third type corresponding to a case where the achievement level is equal to or more than the first reference value and the reading index is equal to or more than the second reference value.

10. The method of claim 1, wherein the providing of the recommended learning content and the recommended book includes:
obtaining a learner knowledge map in which one or more connection relationships between one or more learning contents is defined,
changing at least one connection relationship in the learner knowledge map based on the achievement level and the reading index, and
providing, as the recommended learning content, a learning content connected with a current learning content having the passage by an outgoing edge to the learner interface.

11. The method of claim 10, wherein the changing includes:
changing the at least one connection relationship in the learner knowledge map based on at least one of a target grade of each learning content, a target semester of each learning content, a unit of each learning content, a topic of each learning content, a passage of each learning content, an attribute of each passage, a reading index of each passage, the number of words used in each passage, the number of sentences used in each passage, the number of items associated with each passage, or an attribute of each item.

12. The method of claim 1, wherein the obtaining of the non-descriptive answer and the descriptive answer includes:
obtaining handwriting information inputted to the learner interface by the learner, and
inputting the handwriting information into a pre-trained handwriting recognition model.

13. The method of claim 12, further comprising:
determining whether to further train the pre-trained handwriting recognition model based on the number of grapheme elements or the number of syllables that differs between the correct answer and the non-descriptive answer of the learner, or the difference in the number of strokes between the different grapheme elements or syllables.

14. The method of claim 13, further comprising:
training the pre-trained handwriting recognition model based on a correct answer to the non-descriptive item and the non-descriptive answer,
wherein in the training of the handwriting recognition model, the correct answer is used as a ground truth for input data of the handwriting recognition model.

15. The method of claim 12, wherein the inputting of the handwriting information includes
separating a handwriting object for each item based on a position where each item is placed and a position of handwriting information;
determining a target handwriting recognition model for each handwriting object corresponding to each item from among a plurality of pre-trained handwriting recognition models, based on a detailed type of each item; and
inputting each handwriting object for each item to the determined target handwriting recognition model.

16. The method of claim 15, wherein the detailed type includes at least one of a subjective type, a descriptive type, a selective type, or an OX type.

17. The method of claim 15, wherein the plurality of handwriting recognition models includes:
a first handwriting recognition model trained to convert an input handwriting object into a character string including a character used for notating the language in which learner is currently studying,
a second handwriting recognition model trained to convert the input handwriting object into a numeric string, and
a third handwriting recognition model trained to convert the input handwriting object into an Alphabet string.

18. The method of claim 17, wherein in the determining of the target handwriting recognition model,
the first handwriting recognition model is determined as the target handwriting recognition model for a first handwriting object corresponding to a first item of which the detailed type is a subjective type or a descriptive type,
the second handwriting recognition model is determined as the target handwriting recognition model for a second handwriting object corresponding to a second item of which the detailed type is a selective type, and
the third handwriting recognition model is determined as the target handwriting recognition model for a third handwriting object corresponding to a third item of which the detailed type is an OX type.

19. A device for providing a learning content, the device comprising:
one or more processors; and
a computer readable storage coupled to the one or more processors and having instructions stored therein,
wherein the instructions, when executed by the one or more processors, causes the one or more processors to perform each process of the method according to claim 1.

20. A computer program stored in a computer-readable non-transitory recording medium to execute each process included in the method according to claim 1.
